(19) United States
(12) Patent Application Publication
(10) Pub. No.: US 2005/0251705 A1
(43) Pub. Date: Nov. 10, 2005

(54) Decoding system for decoding port data and a method thereof

(76) Inventor: Chun-Lung Liu, Hsinchu Hsien (TW)

Correspondence Address: RABIN & BERDO, P.C., Suite 500, 1101 14 Street N.W., Washington, DC, 20005, US

(21) Appl. No.: 11/045,052

(22) Filed: Jan. 31, 2005

(30) Foreign Application Priority Data
Apr. 16, 2004 (TW) 93110751

(51) Int. Cl. H04L 12/66

(52) U.S. Cl. 714/48

(57) ABSTRACT

A decoding system for decoding port data by a Baseboard Management Controller (BMC) has a microprocessor, a BMC, and a message display device. The microprocessor broadcasts the port data to a bus. The BMC retrieves the port data from the bus and decodes the port data into a message display code. The message display device then displays the message display code.

### RELATED APPLICATIONS

The present application is based on, and claims priority from, Taiwan Application Serial Number 93110751, filed Apr. 16, 2004, the disclosure of which is hereby incorporated by reference herein in its entirety.

### BACKGROUND

1. Field of Invention

The present invention relates to a decoding system for decoding port data. More particularly, the present invention relates to a decoding system for decoding port data, such as port 80 data, by a BMC (Baseboard Management Controller).

2. Description of Related Art

In computer architecture, the microprocessor usually delivers port data to peripheral devices via different buses, such as ISA (Industry Standard Architecture), PCI (Peripheral Component Interconnect), LPC (Low Pin Count), etc. A port number will be assigned to all port data before delivery to the buses. During the data transmission process, the microprocessor will first broadcast all port data with different port numbers to the buses. Each peripheral device will retrieve the port data with a specific port number from the buses according to the preset configuration.

For example, during the computer initiation procedure, the initiation result will be output to a message display device via this protocol. The microprocessor will first retrieve commands required for Power On Self Test (POST) from the Basic Input Output System (BIOS) during the computer initiation procedure. After executing each command, a corresponding debug port data containing the test result will be broadcast to different buses, such as ISA, PCI, or LPC. The debug port data will be in a form of 8-bit data and with port number 80.

Afterward, a decoder connected to one of those buses and capable of decoding debug port data will retrieve the debug port data from the bus for decoding. For example, an external port 80 debug card can be connected to the ISA or PCI and retrieve the debug data. Alternatively, a built-in hardware decoder connected to the LPC can be employed. After decoding, the debug port data can further be output to a message display device, so the administrator can realize the message represented by the debug port data.

For example, FIG. 1 is a block diagram illustrating a decoding system for decoding the debug port data during the computer initiation procedure in the prior art. The decoding system 10 includes a microprocessor 12, a BIOS 15, LEDs 16, and a built-in hardware decoder 17. The microprocessor 12, the BIOS 15 and the hardware decoder 17 are all connected to the LPC 18. LEDs 16 are connected to the hardware decoder 17. During the computer initiation procedure, the microprocessor 12 will first retrieve commands required for POST from the BIOS 15. The microprocessor 12 will then execute each command and output a debug port data 11 with port number 80 in a form of 8-bit data to LCP 18.

Subsequently, the hardware decoder 17 configured to retrieve the port data with specific port number 80 will constantly monitor all data delivered to the LPC 18 by the microprocessor 12. Once the port data with port number 80 is present, the hardware decoder 17 will retrieve all these port data with port number 80. Therefore, the debug port data 11 with port number will be retrieved by the hardware decoder 17. The hardware decoder 17 then decodes the 8-bit debug port data 11 into a corresponding 8-bit message display code 13. The message display code 13 will be further output to eight LEDs 16 used for displaying the 8-bit message display code 13. By reviewing the system specification, the administrator can recognize the message represented by the message display code 13.

However, the built-in hardware decoder for decoding port data is usually expensive, and significantly increases manufacturing costs and design complexity. Besides, the current built-in hardware decoder is often designed to decode port data with a specific port number only, and is not applicable for decoding port data with other port numbers. This design feature also greatly compromises the capability of the hardware decoder.

### SUMMARY

It is therefore an objective of the present invention to provide a port data decoding system utilizing a Basement Management Controller.

It is another objective of the present invention to provide a port data decoding method utilizing a Basement Management Controller.

In accordance with the foregoing and other objectives of the present invention, a port data decoding system utilizing a BMC is proposed. The decoding system includes a microprocessor, a BMC, and a message display device. The microprocessor broadcasts the port data to a bus. The BMC retrieves the port data from the bus and decodes to a message display code. The message display device then displays the message display code.

In accordance with the foregoing and other objectives of the present invention, a port data decoding method utilizing a BMC is proposed. First, the port data is broadcast to a bus by a microprocessor. Then, the port data broadcast to the bus is constantly monitored and the port data is retrieved from the bus by the BMC. Afterward, decode the port data to a message display code by the BMC. The message display code is further displayed on a message display device.

According to the port data decoding system of the present invention, an additional built-in hardware decoder is no longer required for decoding the port data in the computer system. The BMC, originally designed solely for monitoring different status and already equipped in the computer system, can be employed in decoding and displaying the port data. Further, the BMC has the flexibility to be configured to retrieve port data with different port numbers instead of only port data with a specific port number. The manufacturing cost and design complexity of the computer system can therefore also be reduced.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a block diagram illustrating the port data decoding system in the prior art;

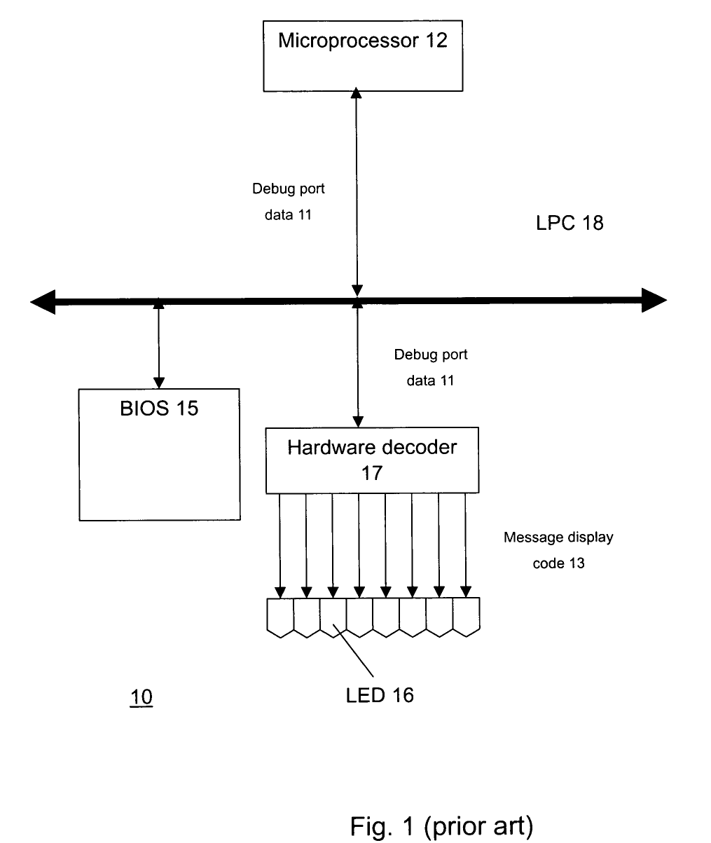

FIG. 2 is a block diagram illustrating the port data decoding system according to the present invention;

FIG. 3 is a block diagram illustrating the port data decoding system according to one preferred embodiment of the present invention; and

FIG. 4 is a flowchart illustrating the port data decoding method according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

A server system is usually equipped with a BMC as a controller. The role of the BMC is to monitor the various status of the server system, such as the temperature and voltage of the server system. The port data decoding method according to the present invention utilizes the computing capability of the BMC to decode the port data. Therefore, an additional hardware decoder is no longer required for decoding port data.

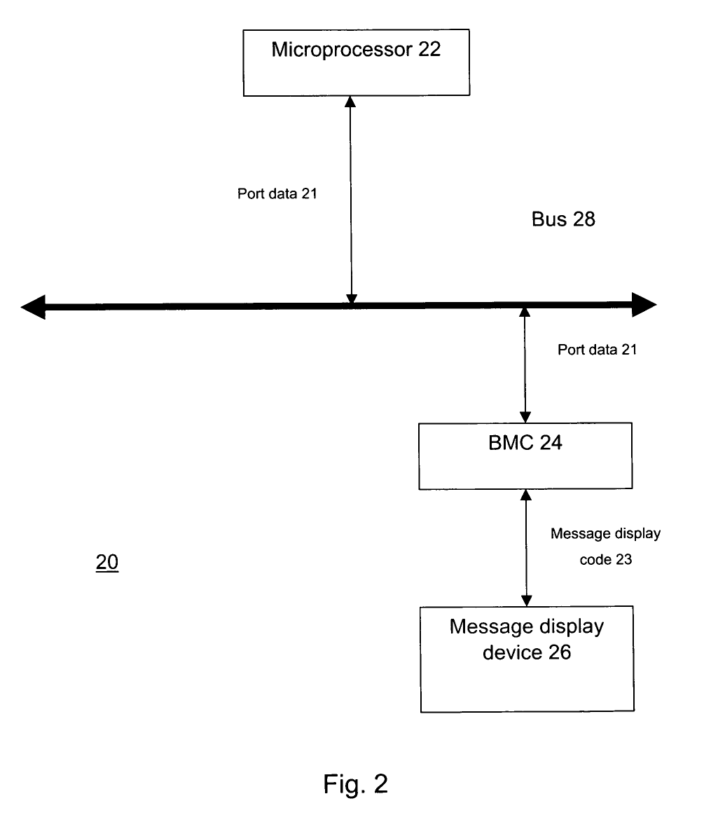

FIG. 2 is a block diagram illustrating the port data decoding system according to the present invention. The decoding system 20 includes a microprocessor 22, a BMC 24, and a message display device 26. The microprocessor 22 and the BMC are both connected to a bus 28. The bus 28 can be ISA, PCI, or LPC. The microprocessor 22 first broadcasts the port data to the bus 28. The BMC 24 constantly monitors the port data delivered to the bus 28, and retrieves the port data with a specific port number based on the preset configuration. Subsequently, the BMC 24 decodes the retrieved port data 21 into a message display code 23. The message display code 23 is then displayed on the message display device 26.

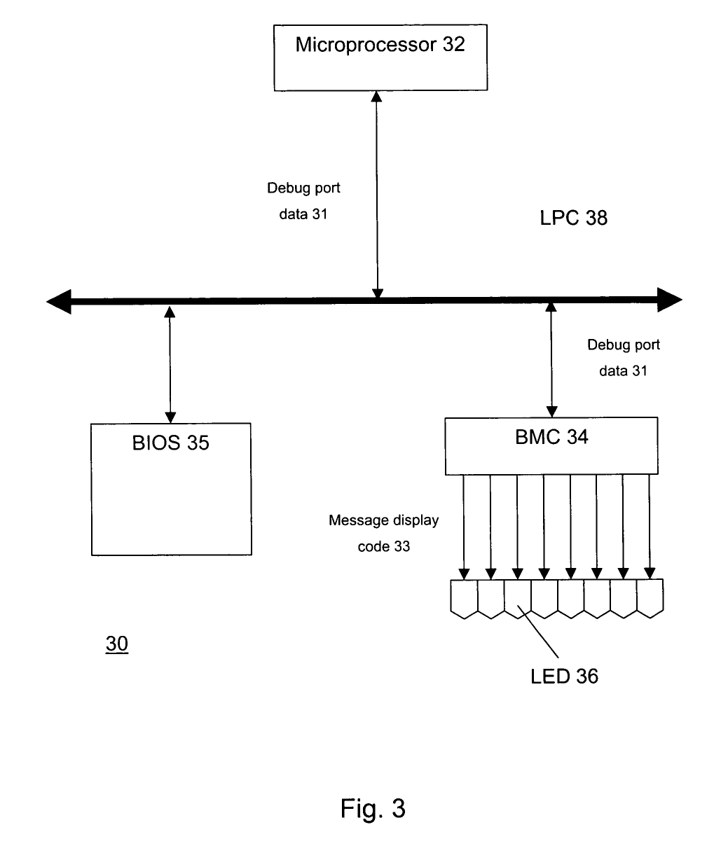

FIG. 3 is a block diagram illustrating the port data decoding system according to one preferred embodiment of the present invention. The port data decoding system is employed in decoding the port data generated during the server initiation procedure. The port data decoding system 30 includes a microprocessor 32, a BMC 34, and LEDs 36. The microprocessor 32 and the BMC 34 are both connected to the LPC 38. LEDs 36 are connected to General Purpose I/O (GPIO) pins of the BMC 34. The GPIO pins of the BMC 34 can function as output pins by programming.

During the server initiation procedure, the microprocessor 32 first retrieves the commands required for POST from the BIOS 35, which is also connected to the LPC 38. The microprocessor 32 executes each command and generates a debug port data 31 containing the test result. The debug port data 31 with port number 80 is in a form of 8-bit data and is broadcast to the LPC 38.

The BMC 34 configured to retrieve port data with port number 80 constantly monitors all data broadcast to the LPC 38. Once the debug port data 31 with port number 80 is broadcast to the LPC 38, the BMC 34 will retrieve these debug port data 31.

After retrieving the debug port data 31, the BMC 34 will load the ISR (Interrupt Service Routine) to decode the debug port data 31. The 8-bit debug port data 31 is then decoded into a corresponding 8-bit message display code 33. The 8-bit message display code 33 will further be output to eight LEDs 16 for display. By reviewing the system specification, the administrator can recognize the POST result represented by the message display code 33.

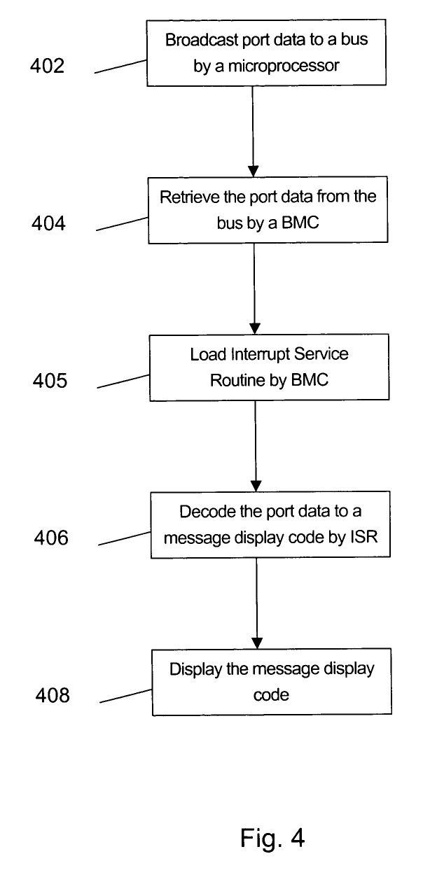

FIG. 4 is a flowchart illustrating the port data decoding method according to the present invention. The port data decoding method according to the present invention utilizes the BMC to decode the port data broadcast to the bus from the microprocessor. First, the port data, such as the debug port data with port number 80 during the server initiation procedure, is broadcast to a bus by a microprocessor (step 402). The bus can be ISA, PCI or LPC. Then, all data broadcast to the bus is constantly monitored and the port data with a specific port number, such as the debug port data with port number 80 during the server initiation procedure, is retrieved from the bus by a BMC (step 404).

After retrieving the port data from the bus, the BMC will load ISR (step 405). ISR decodes the port data to a message display code (step 406). Thereafter, display the message display code on a message display device (step 408).

According to the port data decoding system of the present invention, an additional built-in hardware decoder is no longer required for decoding the port data in the computer system. The BMC, originally designed solely for monitoring different status and already installed in the computer system, can be employed in decoding and displaying the port data. Besides, the BMC has the flexibility to be configured to retrieve port data with different port numbers instead of only port data with a specific port number. The manufacturing cost and design complexity of the computer system can therefore also be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A decoding system for decoding port data, the decoding system comprising:
a microprocessor for broadcasting the port data to a bus;
a basement management controller for retrieving the port data from the bus and decoding the port data into a message display code; and
a message display device for displaying the message display code.

2. The decoding system of claim 1, wherein the port data has a port number 80.

3. The decoding system of claim 1, wherein the decoding system is installed in a server.

4. The decoding system of claim 3, wherein the port data is debug port data of the server during a Power On Self Test.

5. The decoding system of claim 4, wherein the debug port data is 8-bit data.

6. The decoding system of claim 1, wherein the basement management controller decodes the port data into the message display code by Interrupt Service Routine.

7. The decoding system of claim 1, wherein the bus is Low Pin Count.

8. The decoding system of claim 1, wherein the message display device is a Light Emitting Diode.

9. The decoding system of claim 8, wherein the Light Emitting Diode is connected to a General Purpose I/O of the basement management controller.

10. A decoding method for decoding a port data, the decoding method comprising the steps of:
broadcasting the port data to a bus;
retrieving the port data from the bus by a basement management controller;
decoding the port data into a message display code by the basement management controller; and
displaying the message display code.

11. The decoding method of claim 10, wherein the port data has a port number 80.

12. The decoding method of claim 10, wherein the decoding method is employed in a server.

13. The decoding method of claim 12, wherein the port data is a debug port data of the server during Power On Self Test.

14. The decoding method of claim 13, wherein the debug port data is an 8-bit data.

15. The decoding method of claim 10, wherein the step of decoding the port data to the message display code is performed by Interrupt Service Routine.

16. The decoding method of claim 10, wherein the bus is Low Pin Count.

17. The decoding method of claim 10, wherein the message display code is displayed on a message display device.

18. The decoding method of claim 17, wherein the message display device is a Light Emitting Diode.

19. The decoding method of claim 18, wherein the Light Emitting Diode is connected to a General Purpose I/O of the basement management controller.
